(19) United States
(12) Patent Application Publication
(10) Pub. No.: US 2007/0146984 A1
(43) Pub. Date: Jun. 28, 2007

(54) Hinge fastening apparatus

(75) Inventor: Yung-Kun Lin, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/512,271

(22) Filed: Aug. 30, 2006

(30) Foreign Application Priority Data
Dec. 22, 2005 (TW) 094145888

(51) Int. Cl. G06F 1/16

(52) U.S. Cl. 361/683

(57) ABSTRACT

A hinge fastening apparatus is disclosed. The hinge fastening apparatus includes a first housing; a second housing; a hinge module including a first hinge unit connected to the first housing and a second hinge unit connected to the second housing; a latch bracket module including a first end connected to the hinge module and a second end having a opening; and a positioning module, installed on the first housing, having a bulge part, wherein if the positioning module is engaged with the opening, the relative locations of the first and second housings are fixed.

### BACKGROUND OF THE INVENTION

1. Field of the Invention

The present invention relates to a hinge fastening apparatus, and more specifically, to a hinge fastening apparatus providing a device capable of being opened and closed with a mechanism for fastening (i.e., fixing) the closed status of the first and the second housings without the assistance of an exposed hook.

2. Description of the Prior Art

A laptop (i.e., a notebook computer) has several advantages, including having a small-sized volume, being lightweight, and being very convenient for carrying due to its portability. These properties allow a user to work in any location. A small, thin, and light laptop provides the user with powerful computation abilities and document processing functions anywhere and anytime, and thereby the work location of the user is not limited. On the other hand, heavy and large-sized desktop computers do not offer this capability to their users. In recent years, the efficiency of laptops has significantly improved. Many improvements have been in the form of new functions. However, the methods for closing laptops, in other words, the closing mechanisms and devices that have been developed and utilized are usually located on the outside of the laptop's casing. Thereby, the device (i.e., the latching, closing, fixing, fastening device) has a significant impact on the appearance of the laptop. The closing device also mars the laptop's otherwise visually pleasant appearance. Additionally, it is easy for the user to be injured by inadvertently brushing against the closing device.

Please refer to FIG. 1, which is a diagram of a laptop 10 according a related art. As shown in FIG. 1, the laptop 10 includes housings 20 and 30, and a hinge module 40. A liquid crystal display (LCD) screen 22 and a hook 24 are installed on the housing 20. A keyboard module 32, a switch 34, and an opening 36 are installed on the housing 30. One end of the hinge module 40 is fixed on the housing 20, and the other end of the hinge module 40 is fixed on the housing 30. When the housing 20 rotates relatively to the housing 30, the two ends of the hinge module 40 rotate accordingly. The detailed description of the aforementioned operation is now provided. When a user finished jobs for using their laptop 10, the user can close the housing 20 whereas the housing 20 closes down upon the housing 30. This is for the protection of the laptop and for the convenience of carrying it. Particularly, the LCD screen 22 can be protected from being damaged in this way. To prevent the laptop 10 from being opened or closed arbitrarily, it is necessary for the laptop 10 to include a device for temporarily, easily, and quickly fastening the housings 20, 30 to each other. Therefore, when the user closes the laptop 10, the hook 24 is engaged with the opening 36 to latch the laptop 10 thereby preventing it from being opened due any unintentional external forces. When the user intends to open the laptop 10, it is necessary that the user perform a flipping action to cause the switch 34 to push the hook 24. This causes the hook 24 to leave the opening 36 and at this point, the user can open the laptop 10.

Please refer to FIG. 2 for the operation of the hinge module 40. FIG. 2 shows a hinge module 40 shown in FIG. 1. The hinge module 40 includes two hinge units 42 and 44 each capable of rotating relative to one another. After the hinge unit 42 is fixed on the housing 20 and the hinge unit 44 is fixed on the housing 30, the housings 20 and 30 can rotate around the hinge module 40. The structure of the laptop can be strengthening? by installing additional hinge modules 40 in the same way as described here.

The above-mentioned structure is simple and easy to produce. However, the hook 24 cannot be completely hidden within or enclosed by the housing 20, and this is not an optimal solution. Specifically, this is not visually pleasant and the hook 24 may easily scrape or otherwise injure the user. Therefore, the related art discloses a hidden closure structure to solve the above-mentioned hook exposure problem.

A related art hidden closure structure utilizes the friction provided by a hinge module to maintain the open or closed status of the laptop. The disadvantage with this related art method is that the housings 20 and 30 each have their own elastic force resiliency. Therefore, if the hinge module 40 is the only device used for controlling the rotation operations of the housings 20 and 30, the ends of the housings 20 and 30 furthest from the hinge module 40 (i.e., the ends of the housings 20 and 30 where the switch 34 is installed) cannot close sufficiently tight (i.e., close to one another). Additionally, as the hinge module 40 is utilized the friction of the hinge slowly deteriorates. Eventually, when the hinge module 40 is utilized more than a predetermined number of times, the friction of the hinge module is significantly reduced and thereby the rotation operations of the housings 20 and 30 cannot be sufficiently controlled.

### SUMMARY OF THE INVENTION

One of the objectives of the claimed invention is to therefore provide an electronic device providing a mechanism for fixing (i.e., securing) the open/closed status of the electronic device to solve the above-mentioned problem.

According to the claimed invention, a hinge fastening apparatus is disclosed. The hinge fastening apparatus comprises: a first housing; a second housing; a hinge module comprising a first hinge unit and a second hinge unit, the first hinge unit connected to the first housing, and the second hinge unit connected to the second housing; a latch bracket module comprising a first end and a second end, the first end connected to the hinge module, and the second end having a opening; and a positioning module, installed on the first housing, having a bulge part. If the positioning module is engaged by the opening of the latch bracket module, the relative locations of the first and second housings are fixed.

The hinge fastening apparatus according to the present invention utilizes a hinge module, a latch bracket module, and a positioning module to fix the open/closed status of the electronic device. The hinge module rotates to drive a latch bracket module to move forward or backward. When the hinge module rotates to a predetermined angle, the latch bracket module is engaged with the positioning module to prevent the hinge module from further rotating thereby fixing (i.e., securing) the open/closed status of the above-mentioned electronic device. The latch bracket module and the positioning module utilized by the present invention can be installed in the inner side of the first housing or the second housing. Hence, there is no need to utilize any exposed hooks to fasten the first and the second housings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a laptop according a related art.

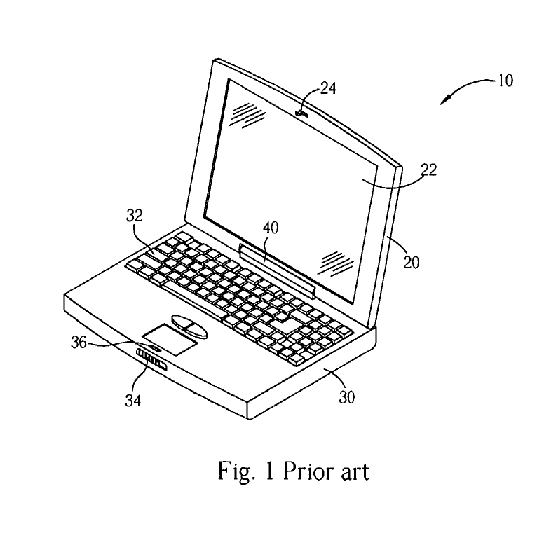

FIG. 2 is an exploded view diagram of the hinge module shown in FIG. 1.

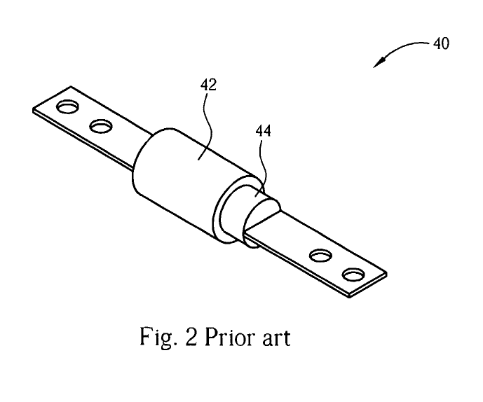

FIG. 3 is functional block diagram of a hinge fastening apparatus according to a preferred embodiment.

FIG. 4 is an exploded view diagram of the lock device, the hinge module, and the upper cover shown in FIG. 3.

FIG. 5 is a diagram of the lock device, the hinge modules, and the upper cover shown in FIG. 4 after the fabrication.

FIG. 6 is a diagram of the release switch, the positioning module, and the front end of the bracket after the release switch shown in FIG. 5 is pressed.

FIG. 7 is a cross-section diagram of the electronic device shown in FIG. 3 comprising the upper cover, the lock device, and the hinge module when the electronic device is in an opened status.

FIG. 8 is a cross-section diagram of the electronic device shown in FIG. 3 comprising the upper cover, the lock device, and the hinge module when the electronic device is in a closed status.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

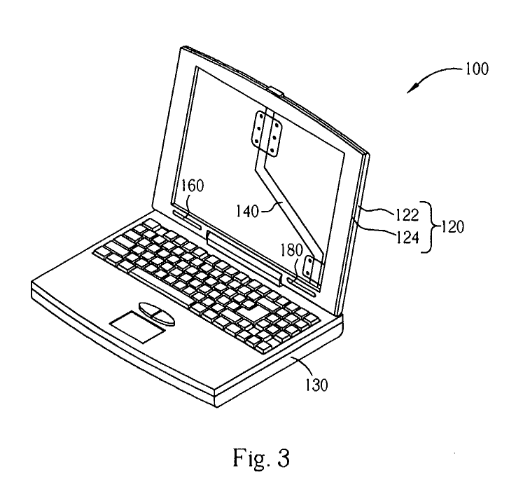

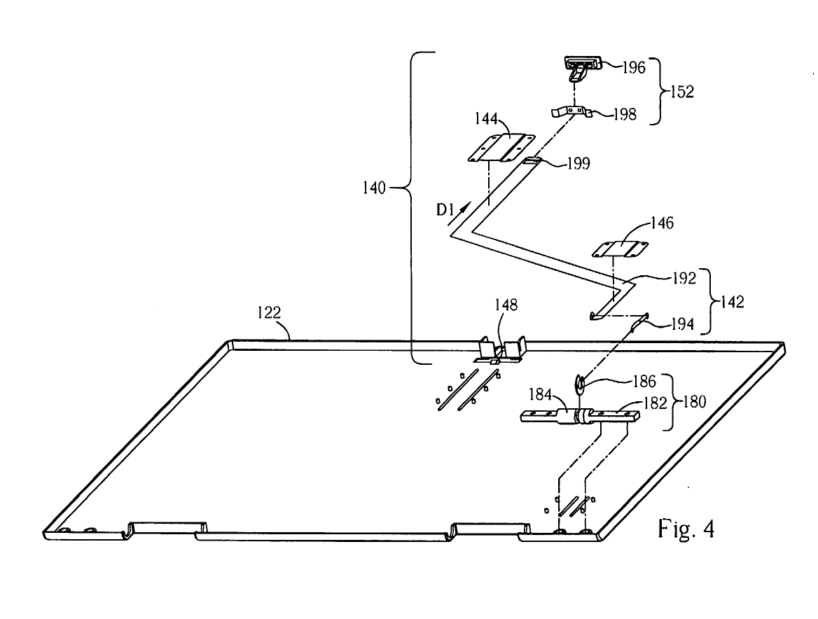

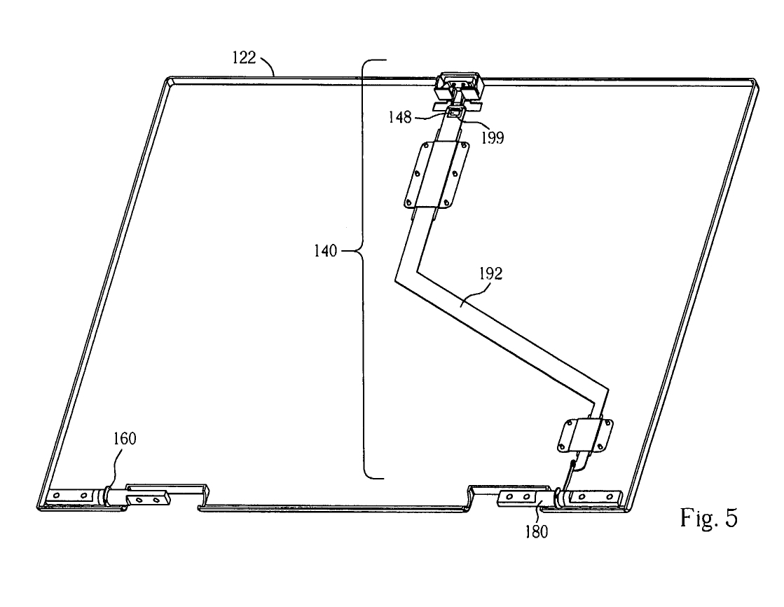

Please refer to FIG. 3, which is functional block diagram of a hinge fastening apparatus 100 according to a preferred embodiment of the present invention. The hinge fastening apparatus 100 applied to a laptop (i.e., a notebook computer) comprises housings 120, 130 and a lock device 140 installed in an inner side of the housing 120. In the present embodiment, the housing 120 is utilized for holding a screen module (not shown), and the housing 130 is utilized for holding a keyboard module. The hinge fastening apparatus 100 further comprises hinge modules 160 and 180 respectively installed on a border between the housings 120 and 130. In addition, the housing 120 comprises an upper cover 122 and a lower cover 124. When a user opens or closes the laptop, the hinge modules 160 and 180 rotate. The hinge module 180 rotates to drive the lock device 140 to fix (i.e., secure) the laptop in either an open status or a closed status. Please refer to FIG. 4 and FIG. 5 for the detailed illustration of the operations and structures of the lock device 140 and the hinge module 180.

FIG. 4 is an exploded view diagram of the lock device 140, the hinge module 180, and the upper cover 122 shown in FIG. 3. FIG. 5 is a diagram of the lock device 140, the hinge modules 160 and 180 and the upper cover 122 shown in FIG. 4 after fabrication. As shown in FIG. 4, the lock device 140 comprises the latch bracket module 142, the linkage fixing slices 144 and 146, the positioning module 148 and the release switch 152. The latch bracket module 142 comprises the bracket 192 and the linkage 194, and the hinge module 180 comprises the hinge units 182 and 184, and the ring 186.

When the user closes the laptop, the hinge unit 184 drives the ring 186 to rotate relative to the hinge unit 182. This movement is achieved because the ring 186 is fixed on the hinge unit 184. Additionally, one end of the linkage 194 is connected to the ring 186, and the other end of the linkage 194 is connected to the bracket 192 using a bolt (not shown). Therefore, the ring 186 rotates to simultaneously drive the linkage 194 and the bracket 192 to move the bracket 192 towards the positioning module 148. Alternatively, when the user opens the laptop, the hinge unit 184 moves the ring 186, the linkage 194, and the bracket 192 to drive the bracket 192 to move away from the positioning module 148. The present invention further utilizes the linkage fixing slices 144 and 146 to install the latch bracket module 142 on the inner side of the upper cover 122. In this way, the latch bracket module 142 can only move in a direction D1 or in an inverse direction; the latch bracket module 142 cannot move in any other directions. In addition, for fixing the closed status after the laptop is closed, the present embodiment utilizes the positioning module 148. The positioning module 148 is a bulge part on an inner side of the upper cover 122. When the bracket 192 moves a predetermined distance in the direction D1, the opening 199 of the bracket 192 is engaged by the bulge part to restrict the movements of the latch bracket module 142 and the hinge module 180. In this way, the lock device 140 can utilize the opening 199 and the positioning module 148 to fix the open/closed status of the laptop. Therefore, when the positioning module 148 is engaged with the opening, the housings 120 and 130 shown in FIG. 3 are fixed at relative positions, and the relative positions are not limited to relative positions when the housings 120 and 130 are closed. In other words, the relative positions can be relative positions when the angle between the housings 120 and 130 is 90 degrees.

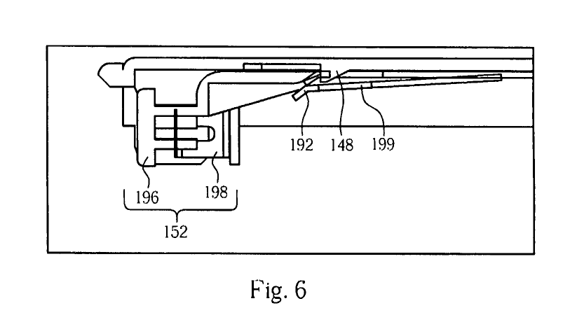

When the relative positions of the housings 120 and 130 indicate that the laptop is closed and the user intends to open the laptop, the user can press the release switch 152 to separate the opening 199 from the positioning module 148 whereby the hinge module 180 can rotate. Please refer to FIG. 6 for the detailed illustration of the operation of the releasing the switch 152. FIG. 6 is a diagram of the release switch 152, the positioning module 148, and the front end of the bracket 192 after the release switch 152 is pressed. The release switch 152 comprises the button 196 and the spring 198. When the opening 199 is engaged with the positioning module (the bulge part) 148, the bracket 192 cannot move arbitrarily. However, when the user presses the button 196, one end of the button 196 lifts the front end of the bracket 192 to drive the opening 199 to separate from the positioning module 148. At this time, the user need only to push the upper cover of the laptop away from the lower cover, and the hinge modules 160 and 180 shown in FIG. 3 can proceed to rotate. Afterwards, when the user releases the button 196, the spring 198 pushes the button 196 thus returning to the regular status.

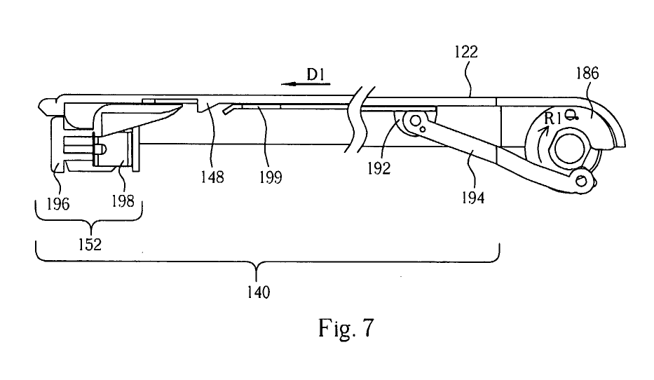

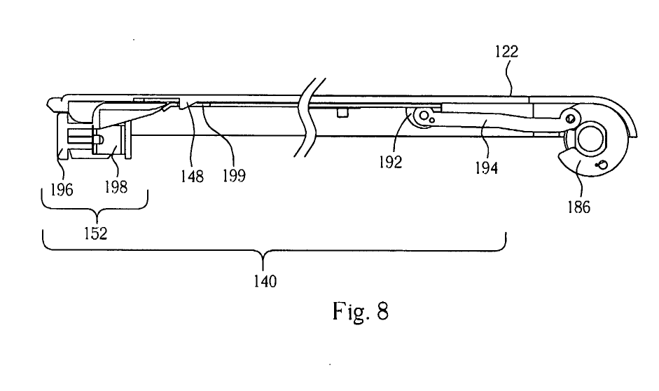

Please refer to FIG. 7 and FIG. 8. FIG. 7 is a cross-section diagram of the laptop comprising the upper cover 122, the lock device 140, and the hinge module 180 when the laptop is opened. FIG. 8 is a cross-section diagram of the laptop comprising the upper cover 122, the lock device 140, and the hinge module 180 when the laptop is closed. As shown in FIG. 7, when the laptop is in the open status, the linkage 194 inclines by an angle such that the bracket 192 is biased to the right and is away from the positioning module 148. Alternately, the linkage 194 shown in FIG. 8 maintains a horizontal status. Therefore the bracket 192 is biased to the left and is engaged with the positioning module 148.

The primary components of the hinge fastening apparatus 100 according to the present invention are installed on the inner side of the housings. Therefore, the fastening mechanism is activated without the assistance of an exposed hook. When the user opens the laptop, the user simply presses the release switch and pushes the upper cover away from the lower cover.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hinge fastening apparatus, comprising:
a first housing;
a second housing;
a hinge module comprising a first hinge unit and a second hinge unit, the first hinge unit connected to the first housing, and the second hinge unit connected to the second housing;
a latch bracket module comprising a first end and a second end, the first end connected to the hinge module, and the second end having a opening; and
a positioning module, installed on the first housing;
wherein if the positioning module is engaged with the opening of the latch bracket module, the first housing and the second housing is fixed in a relative location.

2. The hinge fastening apparatus of claim 1, wherein the positioning module is a bulge part.

3. The hinge fastening apparatus of claim 1, wherein when the hinge module rotates in a rotation direction, the hinge module drives the latch bracket module to move towards the positioning module; when the hinge module rotates in an inverse direction of the rotation direction, the hinge module drives the latch bracket module to move away from the positioning module.

4. The hinge fastening apparatus of claim 1, further comprising:
a release switch, installed on the first housing for pushing the latch bracket module away from the positioning module.

5. The hinge fastening apparatus of claim 1, wherein the hinge module further comprises:
a ring installed on the second hinge unit;
the latch bracket module comprising:
a bracket; and
a linkage, a first end of the linkage connected to the ring, and a second end of the linkage connected to the bracket; wherein when the second hinge unit rotates in the rotation direction, the second hinge unit drives the ring such that the first end of the linkage rotates in the rotation direction to drive the bracket to move towards the positioning module.

6. The hinge fastening apparatus of claim 1, being a clamshell-style electronic device.

7. The hinge fastening apparatus of claim 6, wherein the clamshell-style electronic device is a laptop, the first housing comprises a screen module, and the second housing comprises a keyboard module.

8. The hinge fastening apparatus of claim 7, wherein the clamshell-style electronic device is a laptop, the first housing comprises a keyboard module, and the second housing comprises a screen module.
